(19) United States
(12) Patent Application Publication
(10) Pub. No.: US 2021/0320335 A1
(43) Pub. Date: Oct. 14, 2021

(54) SOLID-STATE THIN FILM BATTERY FOR MICROCOMPUTING DEVICES

(71) Applicant: INTERNATIONAL BUSINESS MACHINES CORPORATION, Armonk, NY (US)

(72) Inventor: Akihiro Horibe, Yokohama-shi (JP)

(21) Appl. No.: 16/845,783

(22) Filed: Apr. 10, 2020

(51) Int. Cl. H01M 10/0585; H01M 4/131; H01M 4/485; H01M 10/0562; H01M 10/46; H01M 10/42; H01M 4/1391; H01M 10/0525; G02C 7/04; G02C 11/00; H02J 7/35

(52) U.S. Cl. CPC H01M 10/0585; H01M 4/131; H01M 4/485; H01M 10/0562; H01M 10/465; H01M 10/4257; H01M 2004/028; H01M 10/4207; H01M 10/0525; G02C 7/04; G02C 11/10; H02J 7/35; H01M 2010/4271; H01M 4/1391

(57) ABSTRACT

A device includes a solid-state thin film battery (STFB) configured for use as an energy storage device of a microcomputing device. The STFB includes an anode and a cathode to account for voltage mismatch by enabling a first electromotive force associated with the STFB to be less than a second electromotive force associated with a photovoltaic device of the microcomputing device.

### BACKGROUND

The present invention generally relates to computing devices, and more particularly to solid-state thin film batteries for powering computing devices.

A photovoltaic device, which is a device including photovoltaic cells for converting sunlight into electricity, can be a useful and efficient power source for a computing device. An energy storage device can be used to supply power to the computing device when the photovoltaic device is incapable of supplying sufficient power (e.g., in a dark environment). One example of an energy storage device is a battery. A battery can include an anode and a cathode separated by an electrolyte. During a discharge cycle, ions move from the negative electrode (e.g., anode) through the electrolyte to the positive electrode (e.g., cathode) and, during a charge cycle, ions move from the positive electrode (e.g., anode) to the negative electrode (e.g., cathode).

### SUMMARY

In accordance with an embodiment of the present invention, a device is provided. The device includes a solid-state thin film battery (STFB) configured for use as an energy storage device of a microcomputing device. The STFB includes an anode and a cathode to account for voltage mismatch by enabling a first electromotive force associated with the STFB to be less than a second electromotive force associated with a photovoltaic device of the microcomputing device.

In accordance with another embodiment of the present invention, a device is provided. The device includes a plurality of power sources of a microcomputing device. The plurality of power sources include a photovoltaic device associated with a first electromotive force between about 1.4V and about 1.8V, and a solid-state thin film battery (STFB) configured for use as an energy storage device for the microcomputing device. The STFB includes an anode and a cathode to account for voltage mismatch by enabling a second electromotive force associated with the STFB to be less than the first electromotive force. The second electromotive force is between about 0.8V and about 1.4V. The device further includes an integrated circuit of the microcomputing device including a power management function to use electrical power from the plurality of power sources and to charge the STFB from the photovoltaic device.

In accordance with yet another embodiment of the present invention, a method for fabricating a computing device is provided. The method includes forming a solid-state thin film battery (STFB) configured for use as an energy storage device for a microcomputing device, and operatively coupling the STFB to a photovoltaic device of the microcomputing device and an integrated circuit of the microcomputing device. The STFB includes an anode and a cathode to account for voltage mismatch by enabling a first electromotive force associated with the STFB to be less than a second electromotive force associated with the photovoltaic device.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of a high-level overview of a computing device, in accordance with an embodiment of the present invention;

FIG. 2 is a diagram of a cross-sectional view of a solid-state thin film battery (STFB), in accordance with another embodiment of the present invention; and

FIG. 3 is a block/flow diagram illustrating a system/method for fabricating a computing device including a solid-state thin film battery (STFB) operatively coupled to a photovoltaic device and an integrated circuit, in accordance with an embodiment of the present invention;

FIG. 4 is a block/flow diagram illustrating a system/method for forming a solid-state thin film battery (STFB), in accordance with an embodiment of the present invention;

FIG. 5 is diagram of an environment for implementing a smart contact lens, in accordance with an embodiment of the present invention; and

FIG. 6 is a block diagram of a smart contact lens that can be implemented within the environment of FIG. 5, in accordance with an embodiment of the present invention.

### DETAILED DESCRIPTION

The embodiments described here provide for a low cost and low toxicity 1V-class solid-state thin film battery (STFB) configured for use as an energy storage device for a microcomputing device. As used herein, the term microcomputing device can refer to a computing device having a thickness of less than about 100 microns. Examples of microcomputing devices described herein include, but are not limited to, micro Internet of Things (IoT) devices. Examples of micro IoT devices include, but are not limited to, implantable healthcare devices. As an illustrative example, the microcomputing device can include, e.g., a smart contact lens.

The microcomputing device can further include a photovoltaic device, and an integrated circuit including a power management function to use electrical power from the STFB or the photovoltaic device, and to charge the STFB from the photovoltaic device. More specifically, the photovoltaic device can be a primary or default power source for the microcomputing device, and the STFB can be a secondary or backup power source when the photovoltaic device is incapable of supplying sufficient power (e.g., in a dark environment). The integrated circuit described herein can include an advanced node semiconductor chip (e.g., less than a 22 nm technology node).

The STFB described herein can include an anode and a cathode configured to account for voltage mismatch by enabling the electromotive force associated with the STFB (Vb) to be less than the electromotive force associated with the photovoltaic device (Vp). The term “electromotive force” generally refers to a difference in potential that tends to generate an electric current. For example, in accordance with the embodiments described herein,Vb is defined as the difference between the cathode potential (Vc) and the anode potential (Va) of the STFB, or Vb=Vc−Va, and the embodiments described herein provide for STFBs that have suitable anode/cathode combinations of materials that can be used to achieve a suitable Vb. Accordingly, the embodiments described herein can account for voltage mismatch without needing a voltage regulation circuit and/or an additional DC-DC converter chip or to allow for high voltage inputs that are not suitable for more cost-sensitive applications, and the use of the STFB can reduce the number of cells needed the photovoltaic device.

It is to be understood that aspects of the present invention will be described in terms of a given illustrative architecture; however, other architectures, structures, substrate materials and process features and steps can be varied within the scope of aspects of the present invention.

It will also be understood that when an element such as a layer, region or substrate is referred to as being “on” or “over” another element, it can be directly on the other element or intervening elements can also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

The present embodiments can include a design for an integrated circuit chip, which can be created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer can transmit the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

Methods as described herein can be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

It should also be understood that material compounds will be described in terms of listed elements, e.g., SiGe. These compounds include different proportions of the elements within the compound, e.g., SiGe includes SiₓGe₁₋ₓ where x is less than or equal to 1, etc. In addition, other elements can be included in the compound and still function in accordance with the present principles. The compounds with additional elements will be referred to herein as alloys.

Reference in the specification to “one embodiment” or “an embodiment”, as well as other variations thereof, means that a particular feature, structure, characteristic, and so forth described in connection with the embodiment is included in at least one embodiment. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, such as “beneath,” “below,” “lower,” “above,” “upper,” and the like, can be used herein for ease of description to describe one element's or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the FIGS. is turned over, elements described as “below” or “beneath” other elements or features would then be oriented “above” the other elements or features. Thus, the term “below” can encompass both an orientation of above and below. The device can be otherwise oriented (rotated 90 degrees or at other orientations), and the spatially relative descriptors used herein can be interpreted accordingly. In addition, it will also be understood that when a layer is referred to as being “between” two layers, it can be the only layer between the two layers, or one or more intervening layers can also be present.

It will be understood that, although the terms first, second, etc. can be used herein to describe various elements, these elements should not be limited by these terms. These terms are only used to distinguish one element from another element. Thus, a first element discussed below could be termed a second element without departing from the scope of the present concept.

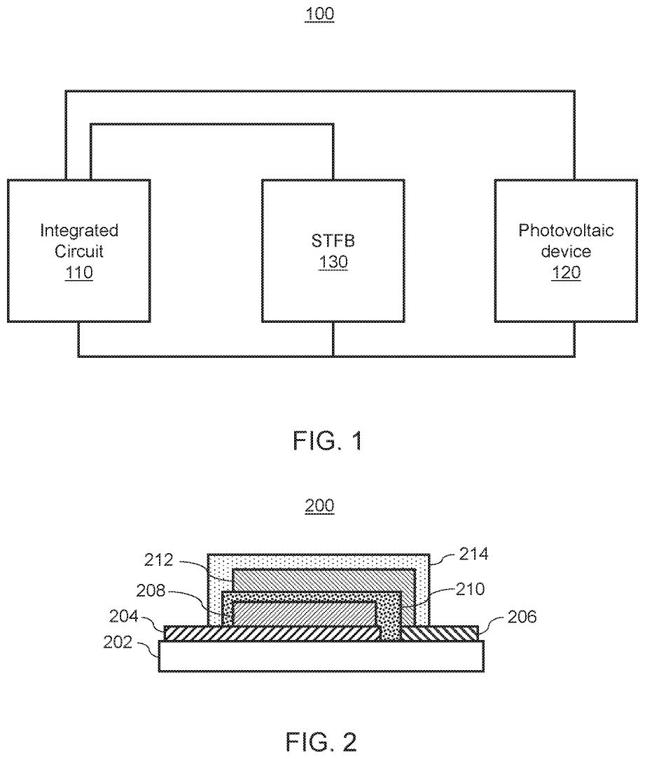

Referring now to the drawings in which like numerals represent the same or similar elements and initially to FIG. 1, a high-level overview of a microcomputing device 100 is shown. Examples of microcomputing devices described herein include, but are not limited to, micro Internet of Things (IoT) devices. Examples of micro IoT devices include, but are not limited to, implantable healthcare devices. As an illustrative example, the microcomputing device 100 can include, e.g., a smart contact lens.

As shown, the device 100 can include an integrated circuit or semiconductor chip 110 operatively coupled to a plurality of power sources including a photovoltaic device 120 and a solid-state thin film battery (STFB) 130. The photovoltaic device 120 and the STFB 130, which can include safe chemicals with low toxicity, can be formed to have suitable thicknesses for use in the device 100.

The integrated circuit 110 can include an advanced node semiconductor chip (e.g., less than a 22 nm technology node). For example, the integrated circuit 110 can include, e.g., a 16 nm node semiconductor chip. Such advanced node integrated circuits can have a lower voltage rating. For example, for a 16 nm node semiconductor chip, the minimum driving voltage (Vmin) can be, e.g., about 0.8 V while the maximum driving voltage (Vmax) can be, e.g., about 1.8 V.

The term “electromotive force” generally refers to a difference in potential that tends to generate an electric current.

The photovoltaic device 120 can include a plurality of photovoltaic cells corresponding to a photovoltaic device electromotive force (Vp). In one embodiment, the photovoltaic device 120 can include between, e.g., 2 and 4 photovoltaic cells corresponding to a Vp of between, e.g., about 1.4 V and about 1.8 V. For example, the photovoltaic device can include, e.g., amorphous silicon (Si) photovoltaic cells.

The STFB 130 is configured for use as an energy storage device for the microcomputing device. More specifically, the photovoltaic device 120 can be a primary or default power source for the device 100, and the STFB 130 can be a secondary or backup power source for the device 100 when the photovoltaic device 130 is incapable of supplying sufficient power (e.g., in a dark environment). The integrated circuit 110 can include a power management function to use electrical power from the plurality of power sources by selecting electric power from the STFB 130 or the photovoltaic device 130, respectively, and to charge the STFB 130 from the photovoltaic device 120. The STFB 130 can be chargeable by the photovoltaic device 120 without a voltage converter. The photovoltaic device 120 and STFB 130 can each have a thickness suitable for use within the device 100 (e.g., less than about 100 microns).

As will be described herein further detail below, the STFB 130 can be a low cost and low toxicity 1V-class STFB including an anode and a cathode configured to account for voltage mismatch by enabling the electromotive force associated with the STFB (Vb) to be less than Vp (e.g., Vmin<Vb<Vp<Vmax). More specifically, Vb is defined as the difference between the cathode potential (Vc) and the anode potential (Va), or Vb=Vc−Va, and the STFB 130 can be formed to have a suitable anode/cathode combination of materials that can be used to achieve a suitable Vb. For example, Vb can be, e.g., between about 0.8 V and about 1.4 V. More specifically, Vb can be between, e.g., about 0.95 V and about 1.25 V. Accordingly, the STFB 130 can account for voltage mismatch without needing a voltage regulation circuit and/or additional DC-DC converter chip to allow for high voltage input, and can minimize the number of photovoltaic cells needed for the photovoltaic device 120.

With reference to FIG. 2, a cross-sectional view of a solid-state thin film battery (STFB) 200 is provided. The STFB 200 can be configured for use as an energy storage device for a microcomputing device including an integrated circuit powered by a photovoltaic device, such as the device 100 described above with reference to FIG. 1. Examples of microcomputing devices described herein include, but are not limited to, micro Internet of Things (IoT) devices. Examples of micro IoT devices include, but are not limited to, implantable healthcare devices. As an illustrative example, the STFB 200 can be configured for use an energy storage device for a microcomputing device including, e.g., a smart contact lens.

As shown, the STFB 200 includes a base structure 202. The base structure 202 can include a substrate. The substrate can include any suitable material in accordance with the embodiments described herein. Examples of suitable materials that can be used to form the substrate include, but are not limited to, silicon (Si), glass, etc.

The base structure 202 can further include one or more current collectors. For example, a current collector can include an adhesion layer formed on the substrate and a current collector layer formed on the adhesion layer.

The adhesion layer can include any suitable material in accordance with the embodiments described herein. For example, the adhesion layer can include, e.g., titanium (Ti). The adhesion layer 204 can have a thickness of, e.g., about 20 nm.

The current collector layer can include any suitable material in accordance with the embodiments described herein. For example, the current collector layer can include, e.g., platinum (Pt). The current collector layer can have a thickness of, e.g., about 70 nm.

Any suitable processes can be used to form the base structure 202 in accordance with the embodiments described herein.

As further shown, the STFB 200 further includes a cathode electrode 204 and an anode electrode 206 formed on the base structure 202. The cathode electrode 204 and the anode electrode 206 can include any suitable electrode material(s) in accordance with the embodiments described herein.

As further shown, the STFB 200 further includes a cathode 208 formed on the cathode electrode 204, an electrolyte 210 formed on the cathode 208 and in contact with the cathode electrode 204 and the base structure 202 separating the cathode electrode 204 and the anode electrode 206, and an anode 212 formed on the electrolyte 210 and the anode contact 206.

For example, the anode 212 can include aluminum (Al) and can have a corresponding anode potential Va of, e.g., less than or equal to about 0.3 V.

As another example, the anode 212 can include indium (In) and can corresponding anode potential Va of e.g., less than or equal to about 0.6 V.

As yet another example, the anode 212 can include bismuth (Bi) and can have a corresponding anode potential Va of e.g., less than or equal to about 0.82 V.

In some embodiments, the anode 212 can include an alloy. Examples of such lithium alloys include, but are not limited to, Al—Li, In—Li, Bi—Li, etc.

The electrolyte 210 can include any suitable material in accordance with the embodiments described herein. In one embodiment, the electrolyte 210 can include a solid electrolyte. For example, the electrolyte 210 can include a ceramic material, such as, e.g., a ceramic solid electrolyte or a glassy ceramic electrolyte. Ceramic solid electrolytes are compounds with crystal structures that usually have ion transport channels, and glassy solid electrolytes are amorphous atomic structures that can include similar materials as ceramic solid electrolytes, but can have higher conductivities overall due to higher conductivity at grain boundaries. Solid electrolytes can enable more effective Li ion transport as compared to liquid electrolytes. Additionally, solid electrolytes can enable the use of, e.g., Li as material for the anode 212. Examples of suitable materials that can be used to form the electrolyte include, but are not limited to, lithium phosphorous oxynitride (LiPON), lithium silicon oxynitride (LiSiOn), etc.

The cathode 208 can include any suitable materials in accordance with the embodiments described herein. Examples of suitable materials that the cathode 208 can be formed from include, but are not limited to, lithium titanium oxide (LTO), lithium molybdenum oxide (LMO), a niobium oxide material (e.g., Nb₂O₅), a vanadium oxide material (e.g., V₂O₅), a molybdenum oxide material (e.g., MoO₃), and ruthenium dioxide (RuO₂). As one illustrative example, the cathode 208 can include Li₄Ti₅O₁₂ having a corresponding cathode potential Vc of about 1.55 V.

The anode 212 can include an anode material and the cathode 208 can include a cathode material to account for voltage mismatch by enabling the electromotive force associated with the STFB (Vb) to be less than the electromotive force associated with the photovoltaic device (Vp). For example, Vb can be between e.g., about 0.8 V and about 1.4 V. In some embodiments, Vb can be between, e.g., about 0.95 V and about 1.25 V. More specifically, since Vb is defined as the difference between the cathode potential (Vc) and the anode potential (Va) (e.g., Vb=Vc−Va), the combination of the anode 212 and the cathode 208 needs to meet an appropriate value of Vb. Accordingly, by having a suitable appropriate anode/cathode combination, the STFB 200 can account for voltage mismatch without needing a voltage regulation circuit and/or additional DC-DC converter chip to allow for high voltage input, and can minimize the number of photovoltaic cells needed for the photovoltaic device of the microcomputing device.

However, it is noted that some cathode materials (e.g., LTO and LMO) may not have sufficient electrical conductivity to function as a cathode to achieve an appropriate Vb value in accordance with the embodiments described herein. Thus, in some embodiments, electrically conductive additives can be used to expand the selection of cathode materials that can be used for the cathode 208. Examples of electrically conductive additives that can be used to form the cathode 208 include, but are not limited to, magnesium (Mg), carbon (C) and aluminum (Al). For example, in the embodiment in which the cathode 208 includes LTO with an electrically conductive additive, the cathode 208 can include Li/Li[Li_{1/4}Mg_{1/8}Ti_{13/8}]O₄, a Li/Li[Li_{1/3}Ti_{5/3}]O₄ carbon composite, Li/Li[Li_{1/4}Al_{1/4}Ti_{3/2}]O₄, etc.

As an illustrative example, if the anode 212 includes aluminum (Al), such that Va=0.3 V, and the cathode 208 includes Li₄Ti₅O₁₂, such that Vc=1.55 V, then Vb=1.25 V.

As another illustrative example, if the anode 212 includes indium (In), such that Va=0.6 V, and the cathode 208 includes Li₄Ti₅O₁₂, such that Vc=1.55 V, then Vb=0.95 V.

The components 208 through 212 can be formed using any suitable process in accordance with the embodiments described herein.

For example, the cathode 208 can be formed by depositing an amorphous material, and performing an anneal process at a suitable temperature and pressure for a suitable length of time to convert the amorphous material into an electrochemically active crystalline material. For example, the anneal process can be performed at a temperature between about 700° C. to about 800° C. at about standard pressure (e.g., about 1 atm) for about 12 hours.

The electrolyte 210 and/or the anode 212 can be formed by using, e.g., physical vapor deposition (PVD). For example, a sputter deposition process such as, e.g., reactive radio frequency (RF) sputtering, can be used to form the electrolyte, and a thermal evaporation process can be used to form the anode 212.

As further shown, a encapsulation layer 214 can be formed along exposed surfaces to protect the cathode 208, the electrolyte 210 and the anode 212. The encapsulation layer 214 can include any suitable dielectric material in accordance with the embodiments described herein. Any suitable process can be used to form the encapsulation layer 214 in accordance with the embodiments described herein.

Although not shown, an additional protection layer can be formed on the encapsulation layer 214. The additional protection layer can include any suitable material in accordance with the embodiments described herein. For example, the protection layer can include e.g., glass. Any suitable process can be used to form the additional protection layer in accordance with the embodiments described herein.

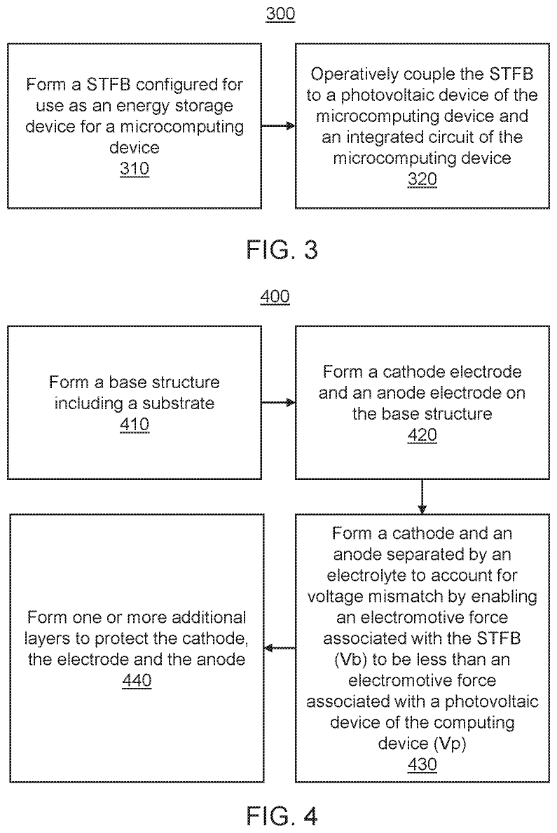

With reference to FIG. 3, a block/flow diagram is provided illustrating a system/method 300 for fabricating a microcomputing device.

At block 310, a solid-state thin film battery (STFB) configured for use as an energy storage device for a microcomputing device is formed. Examples of microcomputing devices described herein include, but are not limited to, micro Internet of Things (IoT) devices. Examples of micro IoT devices include, but are not limited to, implantable healthcare devices (e.g., smart contact lenses).

At block 320, the STFB is operatively coupled to a photovoltaic device of the microcomputing device and an integrated circuit of the microcomputing device. The STFB and the photovoltaic device are included within a plurality of power sources for the microcomputing device. The integrated circuit, or chip, can have a power management function to use electrical power from the plurality of power sources by selecting electrical power from the STFB or the photovoltaic device, respectively, and charge to the STFB from the photovoltaic device. More specifically, the photovoltaic device can be a primary or default power source for the microcomputing device, and the STFB can be a secondary or backup power source for the microcomputing device when the photovoltaic device is incapable of supplying sufficient power (e.g., in a dark environment).

More specifically, the integrated circuit can include an advanced node semiconductor chip (e.g., <22 nm node). For example, the integrated circuit can include, e.g., a 16 nm node semiconductor chip. Such advanced node integrated circuits can have a lower voltage rating. For example, for a 16 nm node semiconductor chip, the minimum driving voltage (Vmin) can be, e.g., about 0.8 V while the maximum driving voltage (Vmax) can be, e.g., about 1.8 V.

The photovoltaic device can include a plurality of photovoltaic cells corresponding to a photovoltaic device electromotive force (Vp). In one embodiment, the photovoltaic device can include between, e.g., 2 and 4 photovoltaic cells corresponding to a Vp of between, e.g., about 1.4 V and about 1.8 V. For example, the photovoltaic device can include, e.g., amorphous silicon (Si) photovoltaic cells.

The STFB can be a 1V-class low-toxicity STFB that includes an anode and a cathode to account for voltage mismatch by enabling the electromotive force associated with the STFB (Vb) to be less than Vp. Accordingly, the STFB account for voltage mismatch without needing a voltage regulation circuit and/or additional DC-DC converter chip to allow for high voltage input, and can minimize the number of photovoltaic cells needed for the photovoltaic device.

Further details regarding blocks 310 and 320 are described above with reference to FIGS. 1 and 2, and will be described in further detail below with reference to FIG. 4.

With reference to FIG. 4, a block/flow diagram is provided illustrating a system/method 400 for fabricating a solid-state thin film battery (STFB) configured for use as an energy storage device for a microcomputing device.

At block 410, a base structure including a substrate is formed. The substrate can include any suitable material in accordance with the embodiments described herein. Examples of suitable materials that can be used to form the substrate include, but are not limited to, silicon (Si), glass, etc.

Forming the base structure can include forming one or more current collectors on the substrate. For example, forming a current collector can include forming an adhesion layer on the substrate, and forming a current collector layer on the adhesion layer.

The adhesion layer can include any suitable material in accordance with the embodiments described herein. For example, the adhesion layer can include, e.g., titanium (Ti). The adhesion layer 204 can have a thickness of, e.g., about 20 nm.

The current collector layer can include any suitable material in accordance with the embodiments described herein. For example, the current collector layer can include, e.g., platinum (Pt). The current collector layer can have a thickness of, e.g., about 70 nm.

The base structure can be formed using any suitable processes in accordance with the embodiments described here.

At block 420, a cathode electrode and an anode electrode are formed on the base structure. The cathode electrode and the anode electrode are separated by a gap. The cathode electrode and the anode electrode can be formed using any suitable processes in accordance with the embodiments described herein. For example, conductive material suitable for use as electrode material can be formed on the base structure, and the conductive material can be patterned to form the cathode and anode electrodes. The cathode and anode electrodes can include any suitable material in accordance with the embodiments described herein.

At block 430, a cathode and an anode separated by an electrolyte are formed to account for voltage mismatch by enabling an electromotive force associated with the STFB (Vb) to be less than an electromotive force associated with a photovoltaic device of the microcomputing device (Vp). For example, Vb can be between e.g., about 0.8 V and about 1.4 V. More specifically, Vb can be between, e.g., about 0.95 V and about 1.25 V. Since Vb is defined as the difference between the cathode potential (Vc) and the anode potential (Va), or Vb=Vc−Va, the anode/cathode combination used to form the STFB needs to achieve an appropriate value of Vb. Such a condition can account for voltage mismatch without needing an additional DC-DC converter chip to allow for high voltage inputs that are not suitable for more cost-sensitive applications and/or a voltage regulation circuit, and can minimize the number of photovoltaic cells needed in the photovoltaic device.

For example, the anode can include aluminum (Al) and can have a corresponding anode potential Va of, e.g., less than or equal to about 0.3 V.

As another example, the anode can include indium (In) and can corresponding anode potential Va of e.g., less than or equal to about 0.6 V.

As yet another example, the anode can include bismuth (Bi) and can have a corresponding anode potential Va of e.g., less than or equal to about 0.82 V.

In some embodiments, the anode can include an alloy. Examples of such lithium alloys include, but are not limited to, Al—Li, In—Li, Bi—Li, etc.

The electrolyte can include any suitable material in accordance with the embodiments described herein. In one embodiment, the electrolyte can include a solid electrolyte. Examples of suitable materials that can be used to form the electrolyte include, but are not limited to, lithium phosphorous oxynitride (LiPON), lithium silicon oxynitride (LiSiOn), etc.

The cathode can include any suitable materials in accordance with the embodiments described herein. Examples of suitable materials that the cathode can be formed from include, but are not limited to, lithium titanium oxide (LTO), lithium molybdenum oxide (LMO), a niobium oxide material (e.g., Nb₂O₅), a vanadium oxide material (e.g., V₂O₅), a molybdenum oxide material (e.g., MoO₃), and ruthenium dioxide (RuO₂).

However, it is noted that some cathode materials (e.g., LTO and LMO) may not have enough electrical conductivity to function as a cathode to achieve an appropriate Vb value in accordance with the embodiments described herein. Thus, in some embodiments, electrically conductive additives can be used to expand the selection of cathode materials that can be used for the cathode. Examples of electrically conductive additives that can be used to form the cathode material of the cathode include, but are not limited to, magnesium (Mg), carbon (C) and aluminum (Al). For example, in the embodiment in which the cathode includes LTO with an electrically conductive additive, the cathode can include Li/Li[Li_{1/4}Mg_{1/8}Ti_{13/8}]O₄, a Li/Li[Li_{1/3}Ti_{5/3}]O₄ carbon composite, Li/Li[Li_{1/4}Al_{1/4}Ti_{3/2}]O₄, etc.

As an illustrative example, if the anode includes aluminum (Al), such that Va=0.3 V, and the cathode includes Li₄Ti₅O₁₂, such that Vc=1.55 V, then Vb=1.25 V.

As another illustrative example, if the anode includes indium (In), such that Va=0.6 V, and the cathode includes Li₄Ti₅O₁₂, such that Vc=1.55 V, then Vb=0.95 V.

Forming the cathode and the anode separated by the electrolyte can include forming the cathode on the cathode electrode, forming the electrolyte on the cathode and within the gap to be in contact with the cathode electrode and the base structure, and forming the anode on the electrolyte and the anode contact.

The cathode, the electrolyte and the anode can be formed using any suitable process in accordance with the embodiments described herein. For example, the cathode can be formed by depositing an amorphous material, and performing an anneal process at a suitable temperature and pressure for a suitable length of time to convert the amorphous material into an electrochemically active crystalline material. For example, the anneal process can be performed at a temperature between about 700° C. to about 800° C. at about standard pressure (e.g., about 1 atm) for about 12 hours. The electrolyte and the anode can be formed by using, e.g., physical vapor deposition (PVD). For example, a sputter deposition process such as, e.g., reactive radio frequency (RF) sputtering, can be used to form the electrolyte, and a thermal evaporation process can be used to form the anode.

At block 440, one or more additional layers are formed to protect the cathode, the electrolyte and the anode. Forming the one or more additional layers can include forming an encapsulation layer along exposed surfaces to protect the cathode, the electrolyte and the anode. The encapsulation layer can include any suitable dielectric material in accordance with the embodiments described herein.

In one embodiment, forming the one or more additional layers at block 440 can further include forming a protection layer on the encapsulation layer. The protection layer can include any suitable material in accordance with the embodiments described herein. For example, the protection layer can include, e.g., glass.

As mentioned above, the embodiments described herein can be used to form a microcomputing device such as, e.g., a micro Internet of Things (IoT) device. Examples of micro IoT devices include, but are not limited to, implantable healthcare devices. As an illustrative example, the microcomputing device can include, e.g., a smart contact lens.

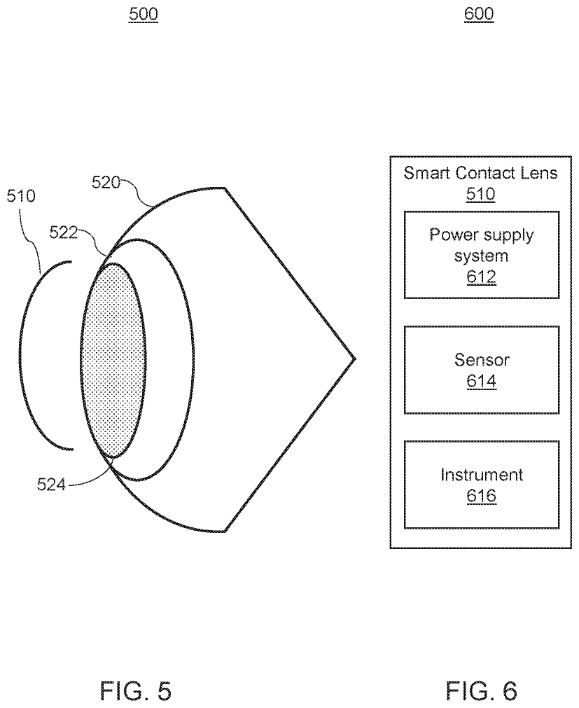

With reference to FIG. 5, an environment 500 is shown for implementing a smart contact lens 510. The environment 500 further includes an eye 520. Although only one smart contact lens 510 is shown configured to be worn on the eye 520, another smart contact lens (not shown) can be provided to be worn on another eye (not shown).

For example, the eye 520 can be a human eye including an iris 522 having a color based on pigment and a pupil 524. Other components of the eye such as, e.g., the cornea, lens and retina, are omitted from FIG. 5. The eye 520 functions by focusing light onto the retina to focus images. The lens of the eye can be controlled by muscles to focus objects at varying distances. The pupil 524 can either dilate or constrict to control the amount of light that enters the eye 520, which can cause the iris 522 to dilate or constrict as well.

For purposes of illustration, the smart contact lens 510 is shown as being separate from the eye 520. When worn on the eye 520, the smart contact lens 510 is directly applied to the eye like a traditional or “non-smart” contact lens. The smart contact lens 510 can be made to withstand stresses such as, e.g., blinking, human touch and exposure to foreign objects, while being made from suitably comfortable and low toxic materials for wearing on the eye 520.

The smart contact lens 510 can be configured to perform one or more tasks. For example, the smart contact lens 510 can be configured to improve or enhance vision. As another example, the smart contact lens 510 can be configured to make recordings by capturing images and/or video within the environment 500. As yet another example, the smart contact lens 510 can be configured to capture biometric data. The smart contact lens 510 can be configured to send data to one or more computing devices for storage and/or processing.

Further details regarding the smart contact lens 510 will now be described below with reference to FIG. 6.

With reference to FIG. 6, a block diagram is provided illustrating a system 600 including the smart contact lens 510. Although not shown, the system 600 can further include at least one computing device in communication with the smart contact lens 510 over a network. For example, the at least one computing device can include a remote device (e.g., a mobile device and/or a wearable device), a server, etc. The at least one computing device can include sensor(s), data storage and/or recording program(s).

As described above, the smart contact lens 510 is a microcomputing device. The smart contact lens 510 can include a power supply system 612. The power supply system 612 can include an integrated circuit, a photovoltaic device and a solid-state thin film battery (STFB), as described above with reference to FIGS. 1-4. More specifically, the photovoltaic device can be a primary or default power source for the smart contact lens 510, and the STFB can be a secondary or backup power source for the smart contact lens 510 when the photovoltaic device is incapable of supplying sufficient power (e.g., in a dark environment). The integrated circuit can include a power management function to use electrical power from the STFB or the photovoltaic device, respectively, and to charge the STFB from the photovoltaic device. An integrated circuit described herein can include an advanced node semiconductor chip (e.g., less than a 22 nm technology node).

As further shown, the smart contact lens 510 can further include a sensor 614. The sensor 614 can be configured to track and/or measure data. For example, the sensor 614 can track changes to pupil size. The sensor 614 can be further configured to measure ambient light within the environment. The sensor 614 can be further configured to obtain biometric data of a user (e.g., heart rate, blood pressure, salinity of the eye, hormone levels, temperature, and blinking rate). The sensor 614 can be further configured to measure a distance between the user and an object being observed by the user. The sensor 614 can be further configured to measure movement data of the eye. The sensor 614 can include other functionality not expressly listed herein related to data tracking and/or measurement.

In this illustrative example, the smart contact lens 510 can further include an instrument 616 configured to make recordings by capturing image and/or video data, and wirelessly transmit the recordings to data storage at the at least one computing device using a wireless transmitter. More specifically, data tracked and/or measured by the sensor 614 can trigger the instrument 616 to initiate image and/or video capture, as described above. For example, pupil size can illustratively be used to determine whether or not to initiate recording of the environment. As another example, biometric and/or movement data of the eye measured by the sensor 614 can initiate capture based on user state (e.g., user excitement).

Having described preferred embodiments of a device and a method of fabricating the same (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A device comprising:
a solid-state thin film battery (STFB) configured for use as an energy storage device of a microcomputing device;
the STFB including an anode and a cathode to account for voltage mismatch by enabling a first electromotive force associated with the STFB to be less than a second electromotive force associated with a photovoltaic device of the microcomputing device.

2. The device of claim 1, wherein the cathode includes a lithium oxide material with an electrically conductive additive.

3. The device of claim 2, wherein the lithium oxide material is selected from the group consisting of: lithium titanium oxide (LTO) and lithium molybdenum oxide (LMO), and the electrically conductive additive is selected from the group consisting of: magnesium (Mg), carbon (C) and aluminum (Al).

4. The device of claim 1, wherein the anode includes a material selected from the group consisting of: aluminum (Al), indium (In) and bismuth (Bi).

5. The device of claim 1, wherein the anode and the cathode are separated by an electrolyte including a material selected from the group consisting of: lithium phosphorous oxynitride (LiPON), lithium silicon oxynitride (LiSiOn), and combinations thereof.

6. The device of claim 1, wherein:
the first electromotive force is between about 0.8V and about 1.4V; and
the second electromotive force is between about 1.4V and about 1.8V.

7. The device of claim 1, wherein the microcomputing device includes a smart contact lens having a thickness of less than about 100 microns.

8. A device comprising:
a plurality of power sources of a microcomputing device, the plurality of power sources including:
a photovoltaic device associated with a first electromotive force between about 1.4V and about 1.8V; and
a solid-state thin film battery (STFB) configured for use as an energy storage device for the microcomputing device, the STFB including an anode and a cathode to account for voltage mismatch by enabling a second electromotive force associated with the STFB to be less than the first electromotive force, wherein the second electromotive force is between about 0.8V and about 1.4V; and
an integrated circuit of the microcomputing device including a power management function to use electrical power from the plurality of power sources and to charge the STFB from the photovoltaic device.

9. The device of claim 8, wherein the cathode includes a lithium oxide material with an electrically conductive additive.

10. The device of claim 9, wherein the lithium oxide material is selected from the group consisting of: lithium titanium oxide (LTO) and lithium molybdenum oxide (LMO), and the electrically conductive additive is selected from the group consisting of: magnesium (Mg), carbon (C) and aluminum (Al).

11. The device of claim 8, wherein the anode includes a material selected from the group consisting of: aluminum (Al), indium (In) and bismuth (Bi).

12. The device of claim 8, wherein the electrolyte includes a solid electrolyte selected from the group consisting of: lithium phosphorous oxynitride (LiPON), lithium silicon oxynitride (LiSiOn), and combinations thereof.

13. The device of claim 8, wherein the microcomputing device includes a smart contact lens having a thickness of less than about 100 microns.

14. A method for fabricating a microcomputing device, comprising:
forming a solid-state thin film battery (STFB) configured for use as an energy storage device for a microcomputing device; and
operatively coupling the STFB to a photovoltaic device of the microcomputing device and an integrated circuit of the microcomputing device, the STFB including an anode and a cathode to account for voltage mismatch by enabling a first electromotive force associated with the STFB to be less than a second electromotive force associated with the photovoltaic device.

15. The method of claim 14 wherein the cathode includes a lithium oxide material with an electrically conductive additive.

16. The method of claim 14, wherein the anode includes a material selected from the group consisting of: aluminum (Al), indium (In) and bismuth (Bi).

17. The method of claim 14, wherein the electrolyte includes a solid electrolyte selected from the group consisting of: lithium phosphorous oxynitride (LiPON), lithium silicon oxynitride (LiSiOn), and combinations thereof.

18. The method of claim 14, wherein the microcomputing device includes a smart contact lens having a thickness of less than about 100 microns.

19. The method of claim 14, wherein:
the first electromotive force is between about 0.8V and about 1.4V; and
the second electromotive force is between about 1.4V and about 1.8V.

20. The method of claim 14, wherein forming the STFB further includes:
forming a cathode electrode and an anode electrode separated by a gap on a base structure including a substrate;
forming the cathode on the cathode electrode;
forming the electrolyte on the cathode and within the gap to be in contact with the cathode electrode and the base structure;
forming the anode on the electrolyte and the anode contact; and
forming one or more additional layers including an encapsulation layer to protect the cathode, the electrolyte and the anode.
